(19) United States
(12) Patent Application Publication
(10) Pub. No.: US 2026/0210154 A1
(43) Pub. Date: Jul. 23, 2026

(54) ROD LINKAGE LOCK WITH HANGING MEMBER

(71) Applicant: WENZHOU YEEKA LOCK TECHNOLOGY CO., LTD., Wenzhou (CN)

(72) Inventors: Wenguang XIANG, Wenzhou (CN); Qianxing Li, Wenzhou (CN); Yanyi Zhou, Wenzhou (CN); Huashan Cai, Wenzhou (CN); Jun Yang, Wenzhou (CN)

(21) Appl. No.: 19/319,751

(22) Filed: Sep. 5, 2025

(30) Foreign Application Priority Data
Jan. 20, 2025 (CN) 202520134962.X

(51) Int. Cl. E05B 13/00; E05B 7/00

(52) U.S. Cl. CPC E05B 13/002; E05B 7/00

(57) ABSTRACT

A rod linkage lock with hanging member, comprising a housing, a handle, and a lug; wherein one end of the handle is mounted in a handle groove of the housing and an other end thereof is a swinging end that can be engaged into the handle groove; wherein the lug is confined in the handle groove and movable between a lockable first position and a second position, the lug is provided with a pushing member; in the lockable first position, a hanging end of the lug can pass through a hole of the handle; when the lug is moved from the lockable first position to the second position, the pushing member pushes the swinging end to protrude out of the handle groove, when the handle is engaged into the handle groove, the handle drives the lug to move from the second position to the lockable first position.

### CROSS-REFERENCE TO RELATED APPLICATIONS

The present application claims the priority of Chinese Utility Model Application No. 202520134962.X, filed on Jan. 20, 2025, the entire contents of which are hereby incorporated by reference.

### TECHNICAL FIELD

This disclosure relates to the lock technology field and in particular to a rod linkage lock.

### BACKGROUND

Since the handle of a rod linkage lock is typically embedded within the handle groove of the housing, during the unlocking operation, one end of the handle needs to protrude from the handle groove to allow the handle to be pulled out for completing the unlocking operation. Consequently, the prior art involves arranging a torsion spring at the pivoting end of the handle, when the handle is engaged into the handle groove, relying on the elastic energy stored in the torsion spring causes the handle to spring out of the handle groove. This arrangement, on the one hand, requires the addition of a torsion spring, which needs a certain pre-compression during installation, resulting in inconvenient assembly. On the other hand, actual user feedback indicates that locks designed with a torsion spring to drive the handle ejection still carry a risk of the handle getting stuck within the handle groove and failing to eject. Therefore, there is a current need to solve the problem of providing a rod linkage lock capable of reliably ejecting the handle from the handle groove when necessary.

Currently, there are also designs that provide assist devices to help the handle eject; such designs are found in general rod linkage locks. However, in some applications, to enhance the flexibility and anti-theft performance of the rod linkage lock, the rod linkage lock will be configured with a lug for a padlock, and the handle will be provided with a structure engaged with the lug (e.g., the hole disclosed in the handle in Chinese Utility Model Patent No. CN201915722U). As the lug occupies installation space within the lock, the overall design space of the lock is significantly constrained, causing it impossible to replicate ejection improvement solutions of the current handle for use in the rod linkage lock with hanging member, thereby increasing the difficulty to the aforementioned improvement designs for the rod linkage lock.

### SUMMARY

An object of the present disclosure is to provide a rod linkage lock with hanging member, which is compact and has a handle that can reliably protrude out of an opening of a handle groove.

In order to achieve the above objective, technical solutions of the present disclosure provide as follows:
A rod linkage lock with hanging member, including a housing, a handle, and a lug; wherein the housing is provided with a handle groove, one end of the handle is mounted in the handle groove via a pivot and an other end thereof is a swinging end that can be engaged into the handle groove, the handle is provided with a lug mating structure corresponding to the lug, which is engaged with the lug for allowing attachment of a padlock, after the handle is engaged into the handle groove, the lug mating structure is a hole penetrating through the handle for a hanging end of the lug to pass through; wherein the lug is slidably arranged in the handle groove along a depth direction of the handle groove, the lug is configured to be confined on the housing and movable between a lockable first position and a second position, when the lug is in the lockable first position, the hanging end of the lug is insertable through the hole of the handle to allow the attachment of the padlock thereto, an operation direction for moving the lug from the lockable first position to the second position is the same as a direction of pressing the lug towards a bottom of the handle groove;
wherein the lug is provided with a pushing member mounted within the handle groove and a driving portion to be driven by the lug, the pushing member has a pushing portion, corresponding to a bottom of the handle and engageable with the handle;
wherein the lug is connected with the driving portion of the pushing member in a movement linkage manner; when the lug is moved from the lockable first position to the second position, the pushing member pushes the swinging end of the handle to protrude out of an opening of the handle groove, when the handle is engaged into the handle groove, the bottom of the handle pushes the pushing member and drives the lug to move from the second position to the lockable first position.

Preferably, the pushing member is a lever structure with its middle part hinged to the housing via a pivot shaft.

Preferably, the driving portion of the pushing member includes a wheel rotating about the pivot shaft, the wheel is provided with teeth, the lug is provided with a rack portion extending along the depth direction of the handle groove, the rack portion is meshed with the teeth for torque transmission, and the pushing portion is an arm radially extending from the wheel.

Preferably, the bottom of the handle groove is provided with a positioning concave cavity, a mounting cover is mounted at the positioning concave cavity, the mounting cover is provided with an opening slot for avoiding interference and allowing the pushing portion of the pushing member to extend therein, and a positioning hole for allowing the hanging end of the lug to there through; the pushing member is positioned and mounted within the positioning concave cavity and confined therein by the mounting cover, an arc-shaped shaft support surface is provided within the positioning concave cavity, the mounting cover is provided with a shaft limiting surface that is engaged with the arc-shaped shaft support surface, the shaft limiting surface and the arc-shaped shaft support surface cooperatively forms a shaft positioning hole, a root portion of the lug is inserted into the positioning concave cavity, the pivot shaft of the pushing member is supported on the arc-shaped shaft support surface and limited thereon by the shaft limiting surface after the mounting cover is mounted at the positioning concave cavity.

Preferably, the handle includes a metal handle body having a hinged portion at one end, a bottom of a grip of the metal handle body has a recess, the bottom of the grip is provided with a plastic liner, the plastic liner has a concave shell portion embedded in the recess, an edge of the shell portion extends outwardly to form a scratch-resistant lip covering an edge of the recess of the bottom of the grip, and the shell portion has a hole-shaped portion on a concave bottom thereof that serves as the lug mating structure shaped as a hole.

Preferably, the bottom of the handle has a recess.

By adopting the above technical solutions, actuating the lug causes the pushing member to push the handle out of the handle groove, thereby enabling the handle to be actively operated to protrude from the handle groove. Moreover, utilizing the lug as the operating component for protruding the handle offers the advantage of a compact structure. Additionally, the overall structure is simple, compact, and reliable in operation. Another advantage is that as the lug moves into the handle groove, the height of the hanging end of the lug protruding from the handle groove decreases, thereby expanding the motional degrees of freedom of the handle. When the handle is engaged into the handle groove, the handle pushes the lug to reset to the lockable first position. That is, after the handle is fully operated, the lug simultaneously lifts and resets, allowing the user to complete the installation of the padlock in one step without requiring operation with two hands, thus avoiding the need to pull the hanging end of the lug to secure the padlock. Therefore, by integrating the functional structure for actively ejecting the handle with the lug, a compact structural arrangement is achieved. Moreover, the operation of the lug and the handle is interrelated, making the lock convenient to use. The handle adopts a design with the plastic liner to prevent scratching.

### BRIEF DESCRIPTION OF DRAWINGS

FIG. 1 is a schematic structural view of a rod linkage lock with hanging member according to the present disclosure.

FIG. 2 is an exploded view of a rod linkage lock with hanging member according to the present disclosure.

FIG. 3 is a schematic structural view of a lug of a rod linkage lock with hanging member in a lockable first position according to the present disclosure.

FIG. 4 is a schematic structural view of a lug of a rod linkage lock with hanging member in a second position according to the present disclosure.

FIG. 5 is a schematic structural view of a housing of a rod linkage lock with hanging member according to the present disclosure.

### DESCRIPTION OF EMBODIMENTS

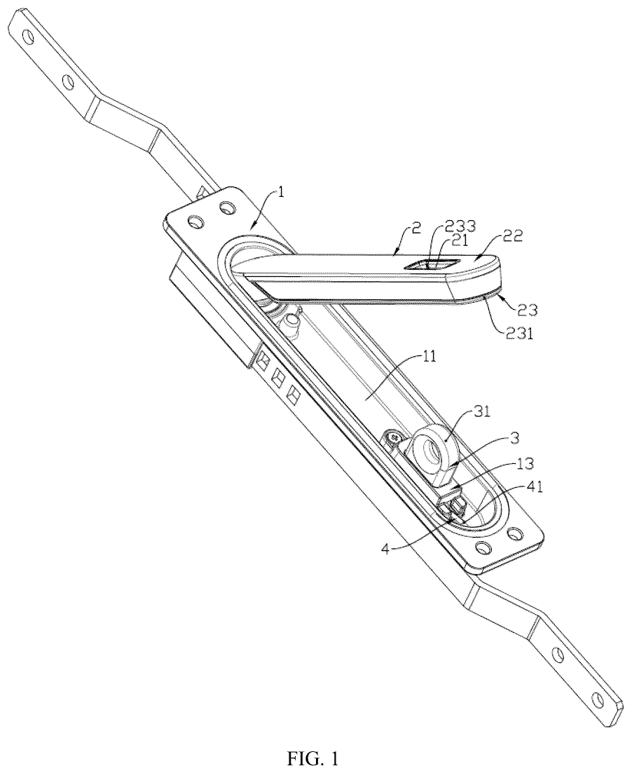

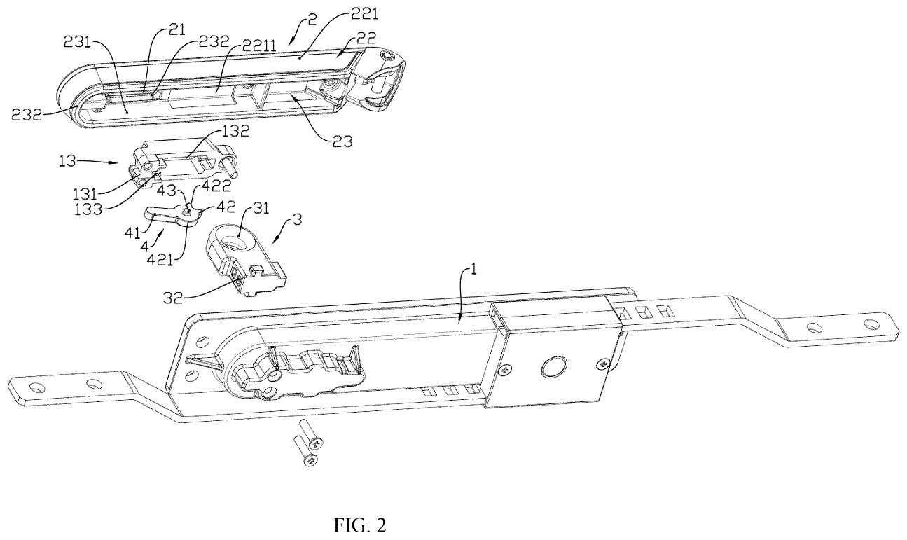

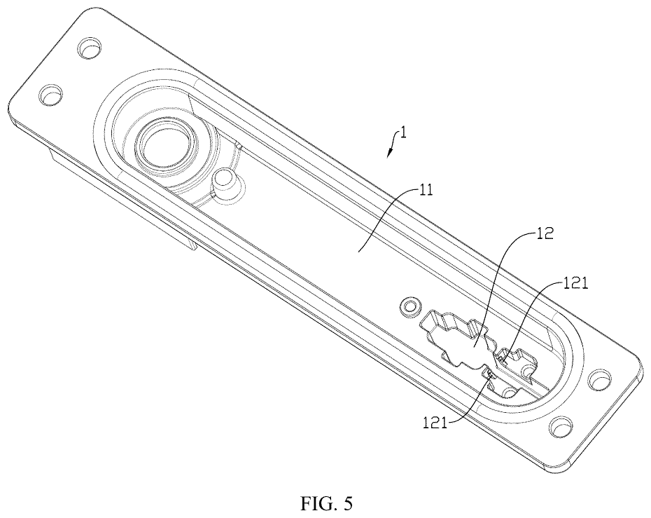

Referring to FIGS. 1 to 5, the present disclosure discloses a rod linkage lock with hanging member, including a housing 1, a handle 2, and a lug 3. The housing 1 is provided with a handle groove 11. One end of the handle 2 is mounted within the handle groove 11 via a pivot 2-1, and the other end of the handle 2 is a swinging end that can be engaged into the handle groove 11. The handle 2 is provided with a lug mating structure corresponding to the lug 3, which is engaged with the lug 3 for allowing attachment of a padlock after the handle 2 is engaged into the handle groove 11.

In this specific embodiment, the lug mating structure is a hole 21 penetrating through the handle 2, allowing a hanging end 31 of the lug 3 having a hanging hole to pass through. Specifically, when the handle 2 is engaged in the handle groove 11, the hanging end 31 of the lug 3 passes through the hole 21 of the handle 2, such that a padlock can be attached to the hanging end 31 and lock the handle 2.

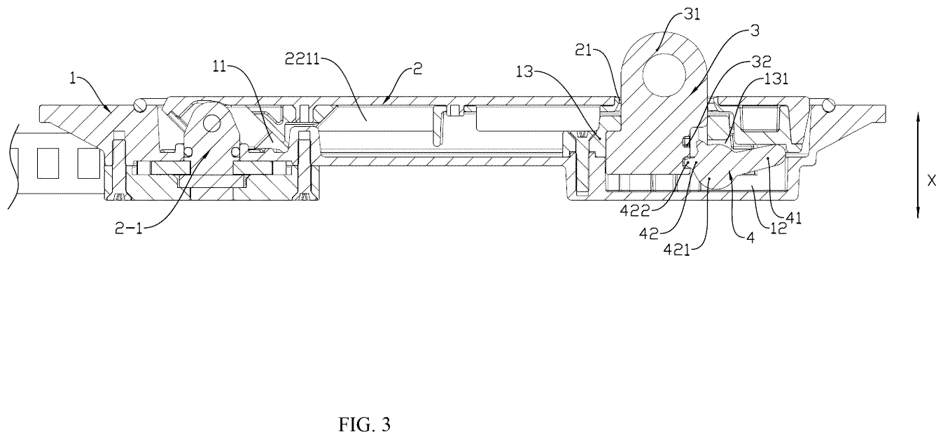

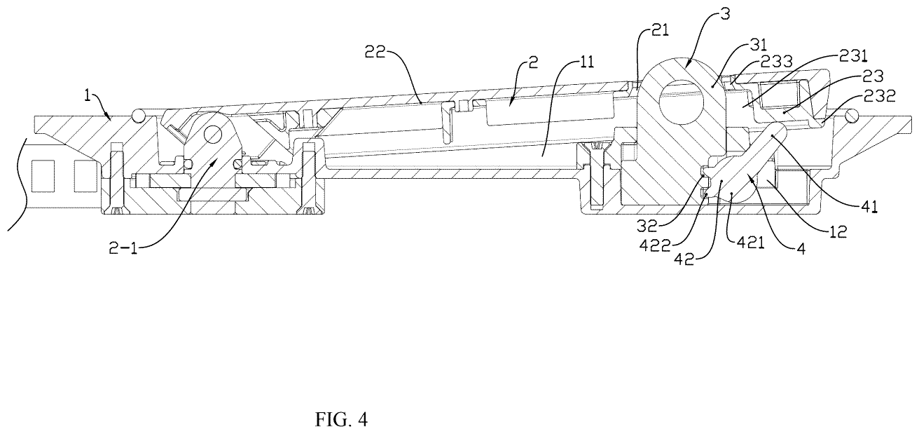

To solve the problem in the prior art that the handle 2 of a rod linkage lock with hanging member may fail to eject, the lug 3 is configured to be confined on the housing 1 and movable between a lockable first position (as shown in FIG. 3) and a second position (as shown in FIG. 4). Thus, the lug 3 can be actuated to move between the lockable first position and the second position. The lug 3 is provided with a pushing member 4. The pushing member 4 has a pushing portion 41 corresponding to a bottom of the handle 2 and engagable with the handle 2, and a driving portion 42 to be driven by the lug 3. When in the lockable first position, the lug 3 is engaged with the lug mating structure to allow attachment of the padlock. When the lug 3 is moved from the lockable first position to the second position, the swinging end of the handle 2 is pushed by the pushing member 4 to protrude out of an opening of the handle groove 11 (as shown in FIG. 4).

This achieves ejection of the swinging end of the handle 2 by operating the lug 3, enabling the handle 2 to be actively operated to protrude out from the handle groove 11, and ensuring reliable protrusion of the handle from the opening of the handle groove. Simultaneously, it realizes a multi-functional design of a single component, making the overall structure compact. Furthermore, in this design, the lug is a necessary operating part for locking and unlocking the handle; performing the handle ejection via this part makes the operation more smooth and convenient to use. In the design of the present disclosure, the hinged end of the handle 2 can be designed without a torsion spring.

The lug 3 is connected to and moves together with the driving portion 42 of the pushing member 4, so that when the handle 2 is engaged into the handle groove 11, the bottom of the handle 2 pushes the pushing member 4 and drives the lug 3 to move from the second position to the lockable first position. This achieves that when the handle is engaged into the handle groove, the handle pushes or presses the pushing portion of the pushing member, and the pushing member drives the lug via the driving portion, resetting the lug from the second position to the lockable first position. Adopting the design with the linkage movement can reduce the number of components.

As discussed above, to achieve a simpler and more compact structure while facilitating the installation and arrangement of the movable lug 3 in the present disclosure. Preferably, the lug mating structure is a hole 21 penetrating through the handle 2, allowing a hanging end 31 of the lug 3 having a hanging hole to pass through. The lug 3 and the pushing member 4 are mounted within the handle groove 11, and the lug 3 is slidably arranged within the handle groove 11 along a depth direction X of the handle groove 11.

By concealing a root portion of the lug 3 and the pushing member 4 within the handle groove 11 and utilizing the space of the housing 1 along its thickness for installation and arrangement, and by adapting the movement direction of the lug 3 to the ejection direction of the handle 2, the installation and arrangement of the lug 3 become more convenient and reliable, and the lug mating structure is more compact. For example, the size of the hole on the handle 2 can be designed as compact as possible, and the movement of the lug is more stable and reliable.

To achieve more convenient and reliable handle ejection, an operation direction for moving the lug 3 from the lockable first position to the second position corresponds to a direction of pressing the lug 3 towards a bottom of the handle groove 11. Thus, pressing the lug 3 towards the bottom of the handle groove 11 can cause the swinging end of the handle 2 to protrude out from the handle groove 11. This operation is labor-saving and convenient. Moreover, the force applied to the lug 3 is more reasonable, making it less prone to damage; and the design of the lug occupies less space, resulting in a more compact structure. When the handle is engaged into the handle groove, the handle drives the lug 3 to lift and reset.

In the unlocking operation of the lock with the above solution, pressing the lug into the handle groove causes the handle to be pushed and protrude from the opening of the handle groove, thereby achieving the function of actively ejecting the handle. Simultaneously, the height of the hanging end of the lug protruding from the handle groove decreases, thus expanding the motional degrees of freedom of the handle. During the locking operation of the lock, when the handle is engaged into the handle groove, the handle pushes the lug to reset to the lockable first position. That is, after the handle is fully operated, the lug simultaneously lifts and resets, allowing the user to complete the installation of the padlock in one step without requiring operation with two hands, thus avoiding the need to pull the hanging end of the lug to secure the padlock. This not only achieves a compact design but also ensures operational synergy, making the lock convenient to use.

Furthermore, the pushing member 4 is a lever structure with its middle part hinged to the housing 1 via a pivot shaft 43. This achieves a simple structure and reliable operation for the pushing member. Pressing the lug 3 enables the pushing member 4 to push the handle 2 to move in the direction of ejecting from the handle groove 11. Those skilled in the art, under the teachings of the present disclosure, can also make corresponding modifications to the design, such as configuring the pushing member as a sliding rack design, where the pushing member is connected to the lug via a gear, utilizing a gear-and-rack design to achieve the same, etc.

A further specific design is described as below. The driving portion 42 of the pushing member 4 includes a wheel 421 rotating about the pivot shaft. The wheel 421 is provided with teeth 422. The lug 3 is provided with a rack portion 32 extending along the depth direction of the handle groove 11. The rack portion 32 is meshed with the teeth 422 for torque transmission. The pushing portion 41 is an arm radially extending from the wheel 421. Torque between the pushing member and the lug is transmitted through the meshing of the teeth, and linkage movement therebetween is achieved, having the advantages of stable and reliable operation. Furthermore, it enables the pushing member to drive the lug to reset when the handle presses the pushing portion of the pushing member. In the lever structure of the pushing member, the driving portion may also be a rod-like structure extending into the bottom of the lug, but this structure presents issues of non-compact connection and insufficient operational reliability. Therefore, the means of the teeth meshing is preferentially adopted.

As an embodiment of the present disclosure, a positioning concave cavity 12 is provided at the bottom of the handle groove 11, and a mounting cover 13 is mounted at the positioning concave cavity 12. The mounting cover 13 is provided with an opening slot 131 for avoiding interference and a positioning hole 132. The opening slot 131 allows the pushing portion 41 of the pushing member 4 to extend therein. The positioning hole 132 for allowing the hanging end 31 of the lug 3 to extend there through. The pushing member 4 is positioned and mounted within the positioning concave cavity 12 and confined therein by the mounting cover 13, an arc-shaped shaft support surface 121 is provided within the positioning concave cavity 12. That is, the positioning concave cavity 12 includes one cavity part for positioning the lug 3 and another cavity part for positioning and installing the pushing member 4. The mounting cover 13 is provided with a shaft limiting surface 133 that is engaged with the arc-shaped shaft support surface 121, and the shaft limiting surface 133 and the arc-shaped shaft support surface 121 cooperatively forms a shaft positioning hole. A root portion of the lug 3 is inserted into the positioning concave cavity 12. The pivot shaft 43 of the pushing member 4 is supported on the arc-shaped shaft support surface 121. After the mounting cover 13 is mounted in place, the hanging end 31 of the lug 3 extends out from the positioning hole 132, the shaft limiting surface 133 of the mounting cover 13 limits the pivot shaft 43 on the arc-shaped shaft support surface 121, and the lug 3 and the pushing member 4 are restrained within the positioning concave cavity 12 by the mounting cover 13. This achieves convenient and reliable positioning and installation of the lug and the pushing member.

To address the issue of possible stuck between the handle and the housing, and to protect both the housing and the handle, the design may be further optimized in such a manner that the handle is formed by multiple parts that are separately machined and then assembled. Specifically, the handle 2 includes a metal handle body 22 with a hinged portion at one end. A bottom of a grip 221 of the metal handle body 22 has a recess 2211. A plastic liner 23 is padded at the bottom of the grip 221. The plastic liner 23 has a concave shell portion 231 embedded in the recess. An edge of the shell portion 231 extends outwardly to form a scratch-resistant lip 232 covering the edge of the recess 2211 at the bottom of the grip 221. The shell portion 231 has a hole-shaped portion 233 on a concave bottom thereof that serves as the lug mating structure shaped as a hole. The plastic liner is utilized for protection, thereby reducing damage caused by impacts during contact between the handle and the housing, as well as between the handle and the lug. Additionally, the recess at the bottom of the handle also serves to avoid interference with the installation area of the lug. When the handle is engaged into the handle groove, the recess at the bottom of the handle allows inserting the part that secures the lug. This achieves positional avoidance, and makes structure compact. In the specific embodiment, the recess is formed by the concave plastic liner; of course, if the handle is a one-piece structure, the recess may be directly formed by the bottom wall of the handle.

What is claimed is:

1. A rod linkage lock with hanging member, comprising a housing, a handle, and a lug; wherein the housing is provided with a handle groove, one end of the handle is mounted in the handle groove via a pivot, and an other end thereof is a swinging end that can be engaged into the handle groove, the handle is provided with a lug mating structure corresponding to the lug, which is engaged with the lug for allowing attachment of a padlock after the handle is engaged into the handle groove, the lug mating structure is a hole penetrating through the handle for a hanging end of the lug to pass through; wherein the lug is slidably arranged in the handle groove along a depth direction of the handle groove, the lug is configured to be confined on the housing and movable between a lockable first position and a second position, when the lug is in the lockable first position, the hanging end of the lug is insertable through the hole of the handle to allow the attachment of the padlock thereto, an operation direction for moving the lug from the lockable first position to the second position is the same as a direction of pressing the lug towards a bottom of the handle groove;
wherein the lug is provided with a pushing member mounted within the handle groove and a driving portion to be driven by the lug, the pushing member has a pushing portion, corresponding to a bottom of the handle and engageable with the handle;
wherein the lug is connected with the driving portion of the pushing member in a movement linkage manner; when the lug is moved from the lockable first position to the second position, the pushing member pushes the swinging end of the handle to protrude out of an opening of the handle groove, when the handle is engaged into the handle groove, the bottom of the handle pushes the pushing member and drives the lug to move from the second position to the lockable first position.

2. The rod linkage lock with hanging member according to claim 1, wherein the pushing member is a lever structure with its middle part hinged to the housing via a pivot shaft.

3. The rod linkage lock with hanging member according to claim 2, wherein the driving portion of the pushing member comprises a wheel rotating about the pivot shaft, the wheel is provided with teeth, the lug is provided with a rack portion extending along the depth direction of the handle groove, the rack portion is meshed with the teeth for torque transmission, and the pushing portion is an arm radially extending from the wheel.

4. The rod linkage lock with hanging member according to claim 2, wherein the bottom of the handle groove is provided with a positioning concave cavity, a mounting cover is mounted at the positioning concave cavity, the mounting cover is provided with an opening slot for avoiding interference and allowing the pushing portion of the pushing member to extend therein, and a positioning hole for allowing the hanging end of the lug to extend there through; the pushing member is positioned and mounted within the positioning concave cavity and confined therein by the mounting cover, an arc-shaped shaft support surface is provided within the positioning concave cavity, the mounting cover is provided with a shaft limiting surface that is engaged with the arc-shaped shaft support surface, the shaft limiting surface and the arc-shaped shaft support surface cooperatively forms a shaft positioning hole, a root portion of the lug is inserted into the positioning concave cavity, the pivot shaft of the pushing member is supported on the arc-shaped shaft support surface and limited thereon by the shaft limiting surface after the mounting cover is mounted at the positioning concave cavity.

5. The rod linkage lock with hanging member according to claim 1, wherein the handle comprises a metal handle body having a hinged portion at one end, a bottom of a grip of the metal handle body has a recess, the bottom of the grip is provided with a plastic liner, the plastic liner has a concave shell portion embedded in the recess, an edge of the shell portion extends outwardly to form a scratch-resistant lip covering an edge of the recess at the bottom of the grip, and the shell portion has a hole-shaped portion on a concave bottom thereof that serves as the lug mating structure shaped as a hole.

6. The rod linkage lock with hanging member according to claim 1, wherein the bottom of the handle has a recess.
